(19) United States
(12) Patent Application Publication
(10) Pub. No.: US 2007/0177916 A1
(43) Pub. Date: Aug. 2, 2007

(54) SHEET CONVEYANCE APPARATUS AND IMAGE FORMING APPARATUS

(75) Inventor: KENJI NINOMIYA, Mishima-Shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/627,557

(22) Filed: Jan. 26, 2007

(30) Foreign Application Priority Data
Jan. 31, 2006 (JP) 2006-021683

(51) Int. Cl. G03G 15/00

(52) U.S. Cl. 399/405

(57) ABSTRACT

An object of the invention is to provide a construction wherein a trouble caused by contact between a conveyed sheet and a charge removing member can be prevented and charge of the sheet can effectively be removed at low cost while the charge removing member does not interfere with the sheet conveyance. A sheet conveyance apparatus according to an exemplary embodiment of the invention includes a discharge roller pair, an electro conductive nonwoven fabric, and a flag. The discharge roller pair conveys the sheet, and the nonwoven fabric removes charge in the sheet. The flag has a flag surface which comes into contact with the sheet conveyed by the discharge roller pair, and the f lag can turn about a pivot by contact with the sheet. In the sheet conveyance apparatus, the nonwoven fabric is provided in the flag within a range where the charge in the sheet S can be discharged to the nonwoven fabric while the nonwoven fabric is not in contact with the sheet.

### BACKGROUND OF THE INVENTION

1. Field of the Invention

The present invention relates to a sheet conveyance apparatus having a function of removing charge from a sheet and an image forming apparatus such as a printer, a facsimile, and a copying machine which includes the sheet conveyance apparatus.

2. Description of the Related Art

An electrophotographic type laser beam printer will be described below as an example of a conventional image forming apparatus. In the laser beam printer, an image signal is produced based on information transmitted from an external information device such as a personal computer, a photosensitive drum in a processing unit is irradiated with a laser beam according to the image signal, and an electrostatic latent image is formed on the photosensitive drum. The electrostatic latent image formed on the photosensitive drum is visualized by toner which is supplied from a development device in the processing unit, and is conveyed to a transfer portion (transfer position) which is located between the photosensitive drum and a transfer roller.

On the other hand, the sheets stored in a sheet cassette are delivered one by one from the upper-most sheet by a sheet feed roller, and the sheet is conveyed to a registration roller pair whose rotation is tentatively stopped. A leading edge of the sheet abuts on a nip of the registration roller pair, and the sheet is continuously conveyed to correct a skew feeding state until a predetermined loop is formed.

After the skew feeding state is corrected, the sheet is conveyed to a transfer portion by the registration roller pair which starts the rotation at timing when a position of the sheet is matched with a position of the toner image on the photosensitive drum. In the transfer portion, the toner image on the photosensitive drum is transferred onto a surface of the sheet by the transfer roller.

After the toner image transfer, the sheet is conveyed to a fixing unit to fix the transferred toner image onto the surface of the sheet. Then, the sheet is discharged onto a discharge tray from a discharge port by a discharge roller pair.

In the case where recording is performed to both the surfaces of the sheet, the discharge roller pair is reversely rotated before a rear edge of the sheet in which the recording is already performed onto one of the surfaces in the above-described manner passes through the discharge roller pair, which allows switch-back conveyance to be performed to the sheet. Therefore, the sheet is guided to a sheet re-feed path and delivered to the transfer portion again. As with the first surface, the transfer and the fixing process are performed, and the sheet is discharged onto the discharge tray from the discharge port by the discharge roller pair.

At this point, sometimes the charge is not completely removed in the sheet discharged from the discharge port, or sometimes the sheet is charged by friction with the conveyance path. Therefore, when the sheet is directly discharged, there is generated a problem that the sheet adheres to the discharge tray, an outside surface of the printer, or the stacked sheet surface in an electrostatic manner. Japanese Patent Application Laid-Open Nos. 10-157905 and 11-263466 dicusses a technique of preventing the problem. Specifically, the charge removing brush for removing the charge from the sheet is provided in the discharge port. The charge removing brush is provided in the discharge port so as to come into direct contact with the sheet discharged from the discharge port.

However, because the conventional charge removing brush has a configuration in which the charge removing brush is in direct contact with the sheet conveyed by the discharge roller pair, the charge removing brush is subject to bending force in discharging the sheet. Particularly, in continuously discharging the sheets, the charge removing brush is repeatedly subject to the bending force. Furthermore, in the double-sided recording of the sheet, the charge removing brush is further subject to the bending force by sheet reciprocating movement caused by the switch-back conveyance of the discharge roller pair. When the charge removing brush is repeatedly subject to the bending force, sometimes bristles of the charge removing brush drop out by the bending force or even there is a potential for the dropout bristles to adhere onto the sheet. In the double-sided recording, the sheet in which the dropout bristles adhere to the sheet is delivered to image forming portion again, which possibly results in a problem of a defective image. Therefore, it is necessary that the charge removing brush be formed by an expensive material having a high repeated-bending-resistant property, or it is necessary that the charge removing brush have a construction in which the bristles hardly drop out even if the charge removing brush is subject to the bending force.

On the other hand, even if the charge removing brush is formed so as to have the high repeated-bending-resistant property, because the charge removing brush has the construction in which the charge removing brush is in direct contact with the sheet, sometimes the leading edge of the conveyed sheet is caught in the charge removing brush, which possibly results in the folded sheet or sheet jam. Therefore, in order to solve the problem, it is necessary that the pair of charge removing brushes be accurately arranged at constant positions with respect to the sheet. This causes a problem that management cost is increased for component accuracy and assembly accuracy in production.

### SUMMARY OF THE INVENTION

In view of the foregoing, an object of the invention is to provide a construction wherein the trouble caused by the contact between the conveyed sheet and the charge removing member can be prevented and the charge of the sheet can effectively be removed at low cost while the charge removing member does not interfere with the sheet conveyance.

In order to achieve the above object, a exemplary construction of the invention is a sheet conveyance apparatus including a conveyance portion which conveys a sheet; a charge removing member which removes charge in the sheet; and a moving member which is formed by an electro conductive member, and which is able to move by contact with the sheet conveyed by the conveyance portion; wherein the charge removing member is moved with the moving member, the charge removing member being not in contact with the conveyed sheet, and being within a range where the charge in the sheet can be discharged into the charge removing member.

According to the invention, the trouble caused by the contact between the conveyed sheet and the charge removing member can be prevented, and the charge of the sheet can effectively be removed at low cost while the charge removing member does not interfere with the sheet conveyance.

### BRIEF DESCRIPTION OF THE DRAWINGS

FIG. 1 is a partially sectional perspective view in which a part of a top cover of a discharge portion according to a first embodiment is removed.

FIG. 2 is a partially sectional view illustrating a conveyance state of the discharge portion according to the first embodiment.

FIG. 3 is a sectional view schematically illustrating a charge removing state in the case where a sheet is in contact with a flag at a leading end of the flag in the discharge portion according to the first embodiment.

FIG. 4 is a partially sectional perspective view schematically illustrating a state in which the sheet ripples in the discharge portion according to the first embodiment.

FIG. 5 is a sectional view schematically illustrating a charge removing state in the case where the sheet is not in contact with the flag at the leading end of the flag in the discharge portion according to the first embodiment.

FIG. 6 is a partially sectional perspective view in which a part of a top cover of a discharge portion according to a second embodiment is removed.

FIG. 7 is a partially sectional perspective view in which a part of the top cover of the discharge portion according to the second embodiment is removed.

FIG. 8 is a partially sectional view illustrating a conveyance state of the discharge portion according to the second embodiment.

FIGS. 9A to 9C are side views illustrating movement of a flag according to the second embodiment and a positional relationship between a shielding portion and a photointerrupter.

FIG. 10 is a sectional view illustrating a schematic configuration of an image forming apparatus including a sheet conveyance apparatus.

### DESCRIPTION OF THE EMBODIMENTS

Exemplary embodiments of the invention will be described in detail with reference to the drawings. However, it is noted that a size, a material, and a shape of a component and relative arrangement thereof, described in the following embodiments, should appropriately be changed according to a configuration and various conditions of an apparatus to which the invention is applied. Accordingly, a scope of the invention is not limited only to the exemplary embodiments unless particularly described.

### First Embodiment

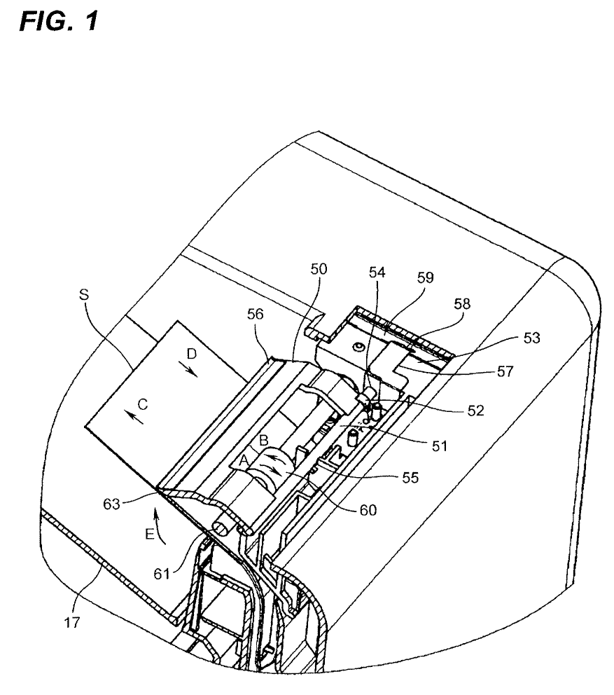

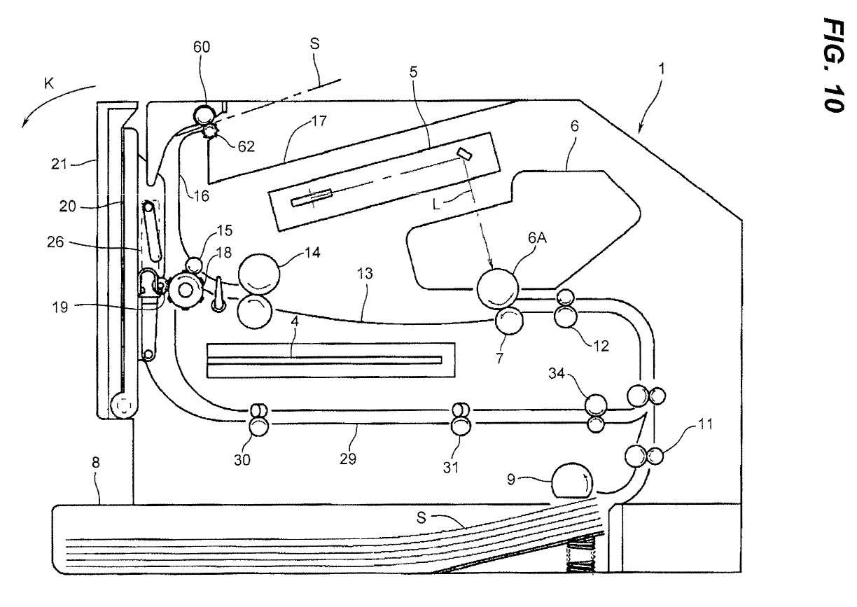

An exemplary embodiment of an image forming apparatus including a sheet conveyance apparatus to which the invention is applied will be described below with reference to the drawings. A schematic configuration of the whole of the image forming apparatus will be described with reference to FIG. 10, and the sheet conveyance apparatus (discharge portion in a first embodiment) in the image forming apparatus will be described with reference to FIGS. 1 to 5.

FIG. 10 is a sectional view illustrating a schematic configuration of a laser beam printer as an example of the image forming apparatus.

In a laser beam printer 1 of FIG. 10, a video controller board (image signal producing member) 4 produces the image signal based on information transmitted from the external information device such as a personal computer and a word processor. Various electronic components mounted on the video controller board 4 are not shown in the drawings. A laser beam scanner 5 irradiates a photosensitive drum 6A rotated clockwise with a laser beam L according to the image signal produced by the video controller board 4, and the electrostatic latent image is formed on the photosensitive drum 6A.

The electrostatic latent image formed on the photosensitive drum 6A is visualized with the toner supplied from a development device (not shown) in the processing unit 6, and the toner image is conveyed to the transfer portion (transfer position) which is located between the photosensitive drum 6A and a transfer roller 7.

On the other hand, sheets S stored in a sheet cassette 8 are delivered one by one from the upper-most sheet S by a semi-circle shaped sheet feed roller 9. The sheet feed roller 9 is counterclockwise rotated one turn. Then, a conveyance roller pair 11 conveys the sheet S to a registration roller pair 12 whose rotation is tentatively stopped.

A leading edge of the sheet S abuts on a nip of the registration roller pair 12, and the sheet S is continuously conveyed to correct the skew feeding state until a predetermined loop is formed.

After the skew feeding state is corrected, the sheet S is conveyed to a transfer portion by the registration roller pair 12 which starts the rotation at timing when a position of the sheet S is matched with a position of the toner image on the photosensitive drum 6A constituting the image forming apparatus. In the transfer portion, the toner image on the photosensitive drum 6A is transferred onto a surface of the sheet S by the transfer roller 7.

After the toner image transfer, the sheet S is conveyed to a fixing roller 14 through a conveyance guide 13, and the transferred toner image is fixed onto the surface of the sheet S.

After the toner image fixing process, in the case where the sheet S is stacked while a recording surface is orientated toward a downward direction, the sheet S passes through a path formed by a conveyance surface 16 and a swing guide 26 facing the conveyance surface 16. Then, the sheet S is discharged by a discharge roller pair 60 and 62 onto a discharge tray 17 which is of a stacking portion located in an upper portion of the printer main body 1.

In the case where the sheet S is stacked while the recording surface is orientated toward an upward direction (face-down stacking), a face-up tray unit 25 is opened in a direction of an arrow K. The face-up tray unit 25 includes a swing guide 26, a rotary tray 20, and an extending tray 21. After the fixing process, the sheet S is discharged by a conveyance roller pair 18 and 15 onto the face-up tray unit 25 located in a side face of printer main body 1.

In the case where the double-sided recording is set, the rear edge of the sheet S in which the recording is performed to one of the surfaces is detected by a detection lever 8 which detects a presence or absence of the sheet S in conjunction with a photointerrupter. After the rear edge of the sheet S passes through the conveyance roller pair 18 and 15, the discharge roller pair 60 and 62 is reversely rotated. Therefore, the rear edge of the sheet S is guided to a nip between the conveyance roller 18 and a driven roller 19, and the sheet S is guided to a sheet re-feed path 29 by the roller pair 18 and 19. The sheet S is conveyed toward the image forming portion again by a roller pairs 30, 31, and 34 in the sheet re-feed path 29, and the sheet S is conveyed to the transfer portion again by the registration roller pair 12 as described above. As with the first surface, the transfer and the fixing process are performed to the sheet S by the processing unit 6A and the fixing unit 14 respectively, and the sheet S is discharged onto the discharge tray 17 by the discharge roller pair 60 and 62.

Then, the sheet conveyance apparatus in the image forming apparatus will be described with reference to FIGS. 1 to 5. In the first embodiment, the sheet discharge portion will be described as an example of the sheet conveyance apparatus. FIG. 1 is a partially sectional perspective view in which a part of a top cover is removed such that the surroundings of the discharge portion of the printer main body can be seen.

The sheet discharge portion includes the discharge roller pair 60 and 62 (conveyance roller) which is of a conveyance portion for discharging and conveying the sheet S. As shown in FIG. 1, the sheet discharge portion also includes an electro conductive nonwoven fabric 56 (electro conductive member) which is of a charge removing member for removing the charge in the sheet S. The sheet discharge portion also includes a contact portion (flag surface 63) which comes into contact with the sheet S conveyed by the discharge roller pair 60 and 62. The sheet discharge portion also includes a flag 50 which is of a moving member for being able to move (flag shaft 51) by the contact with the sheet S.

The flag 50 as a moving member is retained by a flag rotating hole 54, a U groove 55, and a rotation hole (not shown) while being rotatable about the flag shaft 51. The flag rotating hole 54 is made in a frame 53, and the rotation hole is made on the side opposite the flag rotating hole 54. The flag 50 is formed by an electro conductive plastic member in which an electro conductive material such as carbon is added to a plastic member such as POM, PET, ABS, PC, and PBT. At this point, in the flag 50, a volume resistance or a surface resistance is set to 10⁹Ω or less.

The electro conductive nonwoven fabric 56 is provided at a position different from the flag surface 63 of the flag 50 while being not in contact with the sheet S. Specifically, as shown in FIG. 1, the electro conductive nonwoven fabric 56 is attached onto the leading end side in an upper surface of the flag 50 while electrical conductivity exists between the flag 50 and the nonwoven fabric 56.

In a method of attaching the nonwoven fabric 56 to the flag 50, an adhering material is penetrated in a surface side onto which the electro conductive nonwoven fabric is attached, and part of nonwoven fabric fiber can come in direct contact with the flag to establish the electrical conductivity. Alternatively, the electrical conductivity can also be established by placing an electro conductive double-coated tape or an electro conductive adhesion material between the nonwoven fabric and the flag. The flag 50 is made of metal, which allows the electrical conductivity to be established.

A twist coil spring 52 made of metal or an electro conductive elastic material (such as electro conductive POM) is provided in a base of the slag 50, and thereby the electrical conductivity is also established between the flag 50 and a ground plate 57 mounted on the frame 53. A leading end portion 58 of the ground plate 57 is electrically connected to a left side plate 59 constituting a frame of the printer main body. The nonwoven fabric 56 can electrically be connected to the main body frame through the flag 50, the coil spring 52, and the ground plate 57 by the ground path.

The flag surface 63 which is of the contact portion of the flag 50 is arranged on the side of the discharge tray 17 which is located on the downstream side of the discharge roller 60 in the sheet discharge direction. Therefore, when the discharge roller 60 is rotated in the direction of an arrow A by transferring drive of the roller shaft 61 to the discharge roller 60, the flag 50 is lifted in the direction of an arrow E about the flag shaft 51 by the sheet S conveyed in the direction of an arrow C.

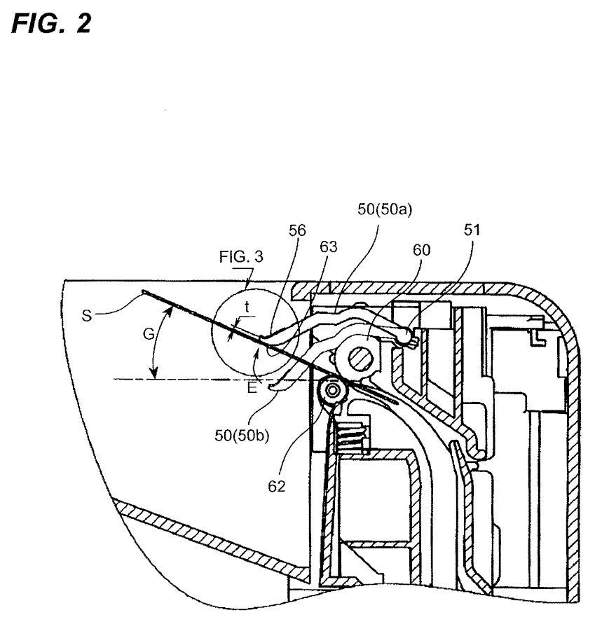

A charge removing method will be described with reference to FIG. 2. FIG. 2 is a partially sectional view illustrating a conveyance state of the discharge portion. Referring to FIG. 2, the position of the flag 50 is indicated by 50a or 50b. A position 50b of the flag 50 indicates a flag position in the case where the sheet S is not conveyed by the discharge roller pair 60 and 62. In this state of things, when the sheet S is conveyed by the discharge roller pair 60 and 62, the flag 50 is lifted to a position 50a about the flag shaft 51 by the sheet. At this point, because a discharge angle G of the sheet S is vertically changed depending on hardness, weight, and a curl amount of the sheet S, an open angle of the flag 50 is changed according to the discharge angle G. However, the nonwoven fabric 56 attached on to the upper side (surface opposite the flag surface 63) in the leading end portion of the flag 50 which is in contact with the sheet S is arranged at a position where the nonwoven fabric 56 is separated away from the sheet S which is in contact with the flag surface 63 of the flag 50 by a thickness t of the leading edge portion of the flag 50. Therefore, in conveying the sheet S, the electro conductive nonwoven fabric 56 can keep a constant distance from the sheet S at the leading edge side of the flag 50 which is brought closest to the sheet S in a contactless manner with conveyed sheet.

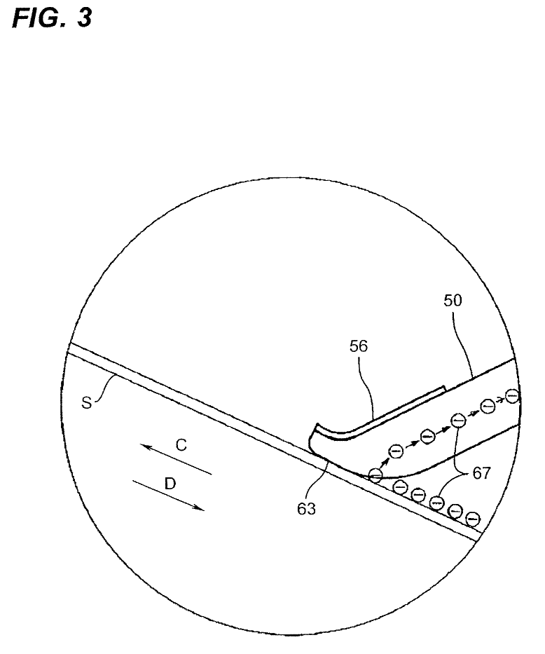

FIG. 3 is a schematic view illustrating charge movement at the leading end portion of the flag in conveying the sheet S. First the case where the flag is made of the electro conductive material will be described. In FIG. 3, because the sheet S is in contact with the flag surface 63, charges 67 in the sheet S are moved to the flag 50 due to the electrical conductivity of the flag 50 The charges 67 moved to the flag 50 are guided to the main body frame (left side plate 59) through the coil spring 52 and the ground plate 57, and the charges 67 are guided to the ground. The sheet S is delivered toward the direction of the arrow C from the discharge roller 60, and thereby the sheet S is discharged toward the delivery direction while the charges 67 in the sheet S are sequentially absorbed in the flag 50. At this point, because the flag surface 63 of the flag 50 is formed by a flat and smooth surface to lower friction force with the sheet S, when the sheet S is discharged while sliding with the flag 60, the flag surface 63 is prevented from interfering with the movement of the sheet S, or the flag surface 63 lowers wear or slide sound of the flag surface 63. In the double-sided recording, when the sheet S is delivered to the printer main body again, the discharge roller 60 of FIG. 1 is reversely rotated in the direction of the arrow B, and the sheet S is conveyed toward the direction of the arrow D. In this case, because the flag surface 63 of the flag 50 is formed by the flat and smooth surface, even in the opposite direction of the arrow D to the direction of the arrow C, the sheet S can be conveyed without being caught by the flag surface 63.

The charge removal in the case where the sheet is in contact with the flag is described above with reference to FIG. 3. Even if the sheet which is of the charge removing target has an undulating surface or irregular surface, because the electro conductive flag is provided while facing the sheet passing surface, it is necessary that the flag be not formed in a sharply-peaked shape which is easy to generate corona discharge but the flag be formed by the electro conductive member having the flat and smooth contact surface. Because the charges can be moved only by the contact method, when the electro conductive flag is slightly separated from the irregular surface of the sheet, the electrical contact is interrupted at that point to hardly remove the charges. Therefore, in the portion where electro conductive flag is separated from the sheet surface, the use of the charge removing fabric or charge removing brush is required to remove the charges by the corona discharge. A construction in which the charge removing fabric is used will be described below. The charge removing fabric is formed in a sheet shape in which metal fibers or electro conductive fibers such as carbon entwine randomly, and the charge removing fabric is used by cutting the charge removing fabric in a desired size. In cutting the charge removing fabric, the electro conductive fibers constituting the charge removing fabric are cut one by one at a cutting surface. The corona discharge is easily generated at the leading edge of the cut electro conductive fibers, which enables the charges to be removed by the discharge. Particularly, in the nonwoven fabric formed by extremely-thin fibers in which electronic conjugation polymer entwines in whole, high discharge efficiency is obtained because the number of fiber leading edges exposed to the cutting surface is increased.

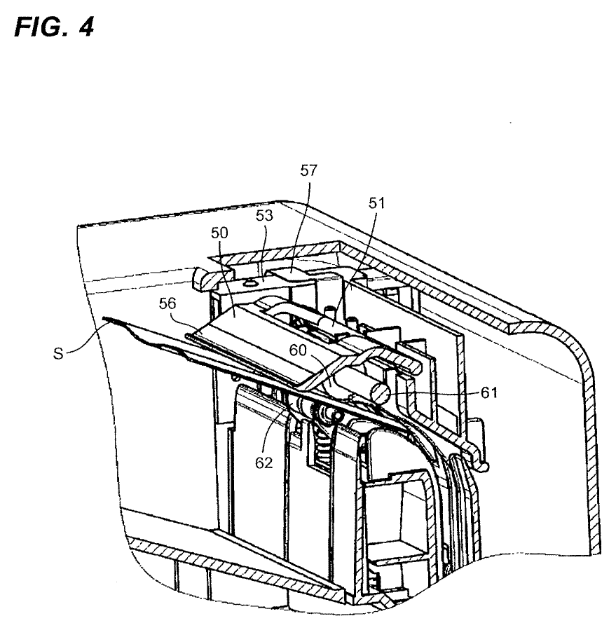

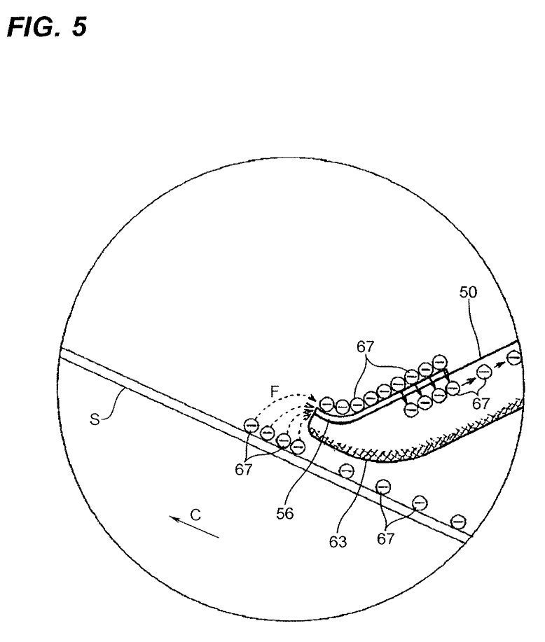

Then, the case where the flag is separated from the sheet will be described with reference to FIG. 4. In the case the discharged sheet S undulates in a width direction intersecting the conveying direction, the sheet S comes into contact only with a wave top portion of the flag 50. This state is illustrated in FIG. 5. FIG. 5 is a sectional view schematically illustrating the charge movement at the leading end portion of the flag 50 in the portion where the flag 50 and the sheet S are not in contact with each other. In FIG. 5, the sheet S is discharged toward the direction of the arrow C. When the charges 67 of the sheet S are delivered near the leading end portion of the flag 50, the charges 67 fly in the direction of an arrow F toward the nonwoven fabric 56 near the flag leading end portion, namely, the charges 67 are discharged, and the charges 67 are moved to the nonwoven fabric 56. The cutting surface of the nonwoven fabric 56 has a thickness of the portion which is located above the adhesion surface between the nonwoven fabric 56 and the flag 50 shown in FIG. 5. When the nonwoven fabric 56 is cut in the rectangular shape, the four cutting surface are exposed in the four directions. Because the fibers in the nonwoven fabric 56 are electrically connected to the flag 50, the charges 67 moved to the nonwoven fabric 56 are moved onto the side of the flag 50, and the charges 67 are similarly removed. In this case, the distance between the nonwoven fabric and the sheet surface is set to 3 mm or less where the charges can be discharged, which allows the charges to be effectively removed. Therefore, a plate thickness t of the flag leading edge is set to about 1 mm from the standpoints of plastic member strength and resin flow properties in molding.

As shown in FIG. 5, the charges in the sheet S can be adsorbed to the nonwoven fabric 56 by arranging the nonwoven fabric 56 at a dischargeable distance. The charges can securely be removed by the contact between the sheet and the lever member. However, even if the sheet is partially separated from the lever member due to the irregularity of the sheet, the charges can well be removed as a whole by supplementing the shortage of the charge removal with the discharge to the contactless charge removing member.

The charge removal in the case where the sheet is not in contact with the flag is described above with reference to FIG. 3. However, the nonwoven fabric is arranged at the position where the nonwoven fabric is separated away from the flag by the flag thickness t (about 1 mm), which allows the charge in the sheet to be discharged into the nonwoven fabric. Therefore, in the case of the flag made of the insulating material, the charges are directly discharged into the nonwoven fabric. When the charges are accumulated in the nonwoven fabric to a certain extent, the charges are naturally discharged in air. The charges in the nonwoven fabric can effectively be removed by providing an electro conductive path between the nonwoven fabric and the main body frame with the ground plate or the like. The use of the electro conductive flag of the first embodiment shows one construction of the electro conductive path between the nonwoven fabric and the ground, and the construction can be provided with no additional electro conductive member. Therefore, the construction of the first embodiment has the effect in cost reduction.

In the first embodiment, unlike the conventional technique in which the charge removing member is arranged at the fixed position, the lower surface of the swinging flag 50 is set at the surface which is in contact with the sheet S, and the nonwoven fabric 56 is attached to the upper surface of the flag 50 while being not in contact with the sheet S. Therefore, in the case where the sheet discharge angle is changed depending on a sheet type or an environment, the nonwoven fabric 56 can keep the constant distance from the sheet S while being not in contact with the sheet S. Even if the sheet and the nonwoven fabric is slightly separated from each other by the sheet undulation in the width direction of the sheet, the distance between the sheet and the nonwoven fabric can be suppressed within the range where the charges in the sheet are discharged into the nonwoven fabric. The wear of the nonwoven fabric, engagement between the sheet and the nonwoven fabric, breakage due to repeated bending of the charge removing member generated in the conveyance path where the sheet is reciprocally moved can be prevented because the nonwoven fabric is not brought into contact with the sheet.

Thus, according to the first embodiment, the problem caused by the contact between the conveyed sheet S and the charge removing member can be prevented, and the charges in the sheet can effectively be removed at low cost while the charge removing member does not interfere with the sheet conveyance.

Not only the charge removing member (nonwoven fabric 56) is provided on the leading end side in the upper surface of the flag 50, but also the lower surface on the leading end side of the flag 50 is set at the surface (flag surface 63) which is in contact with the sheet, which allows the lower surface of the flag 50 to correspond only to the sheet conveyance. For example, in FIG. 5, the flag surface 63 of the flag 50 is modified in the flat and smooth slide surface in a limited manner, surface coating such as UV coating is performed to the flag surface 63, or a polymer polyethylene film is attached to the flag surface 63, and there by the wear-resistant surface can easily be formed.

### Second Embodiment

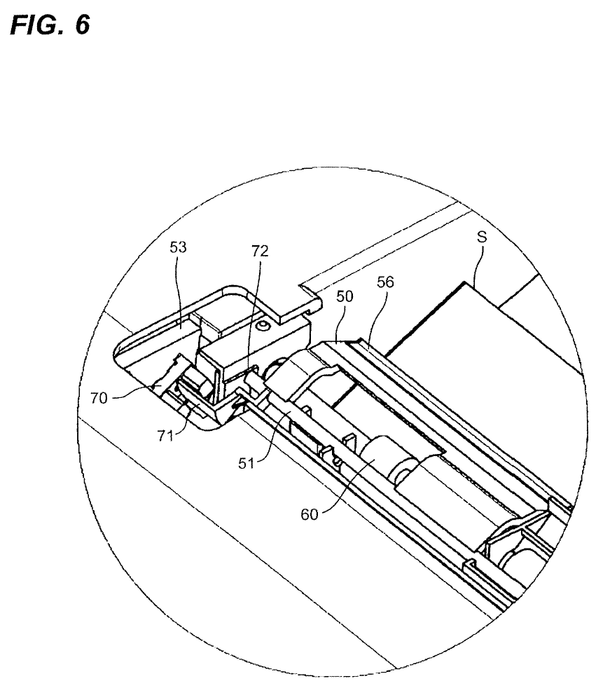

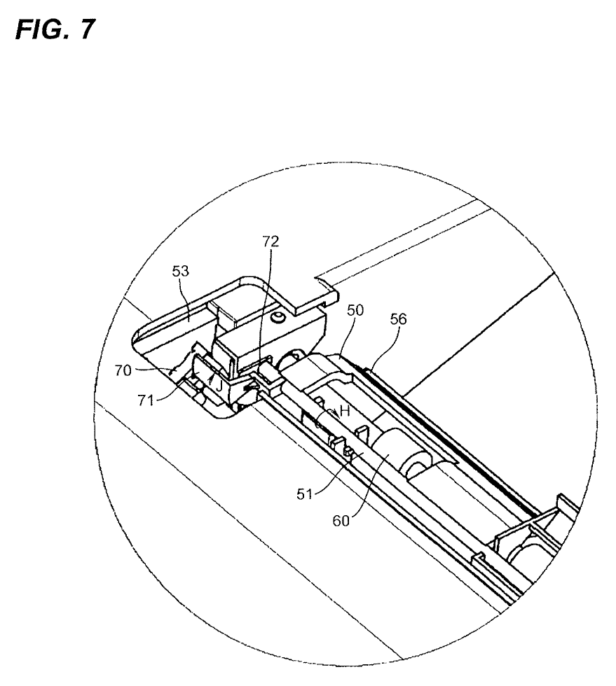

FIGS. 6 and 7 are a partially sectional perspective view in which a part of a top cover is removed to see surroundings of a discharge portion according to a second embodiment, and particularly FIGS. 6 and 7 are a perspective view illustrating a construction and an operation of a flag.

In the second embodiment, the discharge portion includes an optical sensor such as the photointerrupter and a shielding portion 71. In the shielding portion 71, the flag 50 (detection member) which is of the moving member turns on and off the optical sensor. Only the constructions which are different from those of the first embodiment will be described in detail. In the second embodiment, the component having the function similar to that of the first embodiment is designated by the same numeral.

FIG. 6 is a partially sectional perspective view in which a part of the top cover is removed so as to see the surroundings of the discharge portion printer main body. FIG. 6 illustrates the opposite side to FIG. 1. A photointerrupter 70 which is of the optical sensor is attached to the frame 53. The arc-shape shielding portion 71 which interrupts a light source of the photointerrupter 70 is attached to an end portion of the flag 50. The shielding portion 71 turns along with the flag 50 when the flag 50 is lifted about a rotation hole 72 by the discharge of the sheet S. FIG. 6 illustrates the case where the sheet S is being discharged, and the shielding portion 71 of the flag 50 is located at the position where the shielding portion 71 interrupts the light source of the photointerrupter 70. On the other hand, FIG. 7 illustrates the case where the sheet S does not exist in the discharge portion. In FIG. 7, the flag 50 is rotated in the direction of the arrow H compared with the flag 50 of FIG. 6, and the shielding portion 71 is also moved in the direction of the arrow J so as not to interrupt the light source of the photointerrupter 70. Therefore, the flag 50 can detect the presence or absence of the sheet S in the discharge portion.

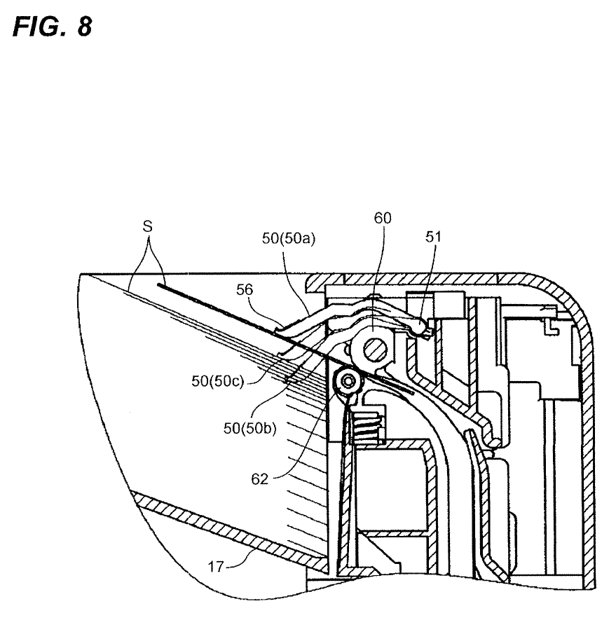

FIG. 8 is a partially sectional view illustrating the surroundings of the discharge portion similar to FIG. 1. In FIG. 8, attitude positions which can be taken by the flag 50 include a position 50a in discharging the sheet, a position 50b located in the lowest portion, and a position 50c located between the position 50a and the position 50b. The flag position 50c is a limit stacking height position (full stacking position). In the limit stacking height position, a predetermined amount of sheets are stacked on the discharge tray 17 to close the discharge port, and the sheet cannot normally be stacked any more. The flag position 50c is arranged so as to be detected by the photointerrupter 70.

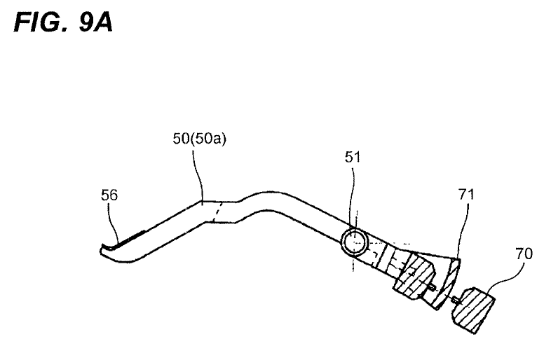

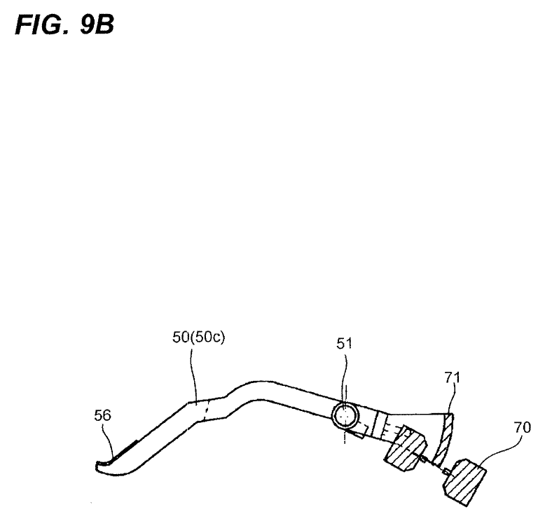

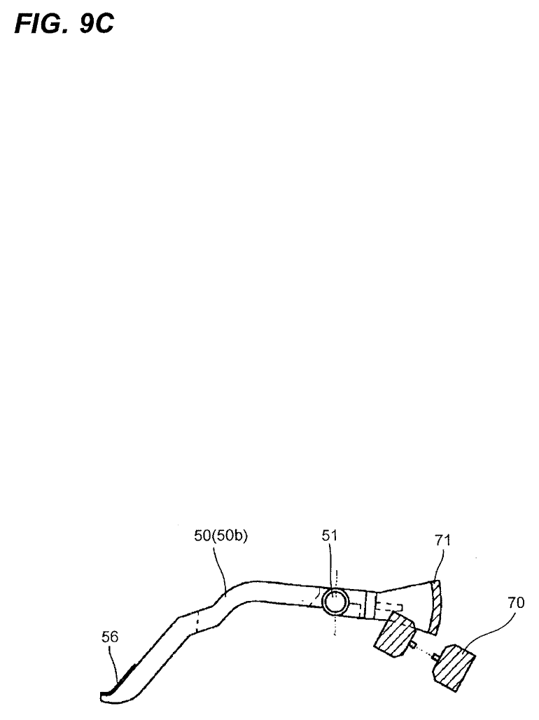

As shown in FIG. 9, in the state of the flag position 50a, the shielding portion 71 of the flag 50 interrupts the light source of the photointerrupter 70, and the photointerrupter 70 detects the interruption of the shielding portion 71 as an ON state. The flag 50 is rotated counter clockwise from the position 50a, and the shielding portion 71 interrupts the light source of the photointerrupter 70 (ON state) until the flag 50 reaches the position 50c. When the flag 50 is further rotated counterclockwise from the position 50c, the shielding portion 71 does not interrupt the light source, and the photointerrupter 70 detects that the shielding portion 71 is located at an OFF position.

The OFF position corresponds to the flag position 50b. The OFF position is in the state in which the no sheet is discharged by the discharge roller pair 60 and 62 or in the state in which the sheets stacked on the discharge tray 17 is lower than the position 50b of the flag 50.

When the sheet S is discharged by the discharge roller pair 60 and 62, the flag 50 is lifted from the position 50b to the position 50a which is located higher than the position 50c, which turns on the photointerrupter 70. Therefore, the optical sensor detects that the leading edge of the sheet S reaches the discharge portion. The photointerrupter 70 is turned on while the sheet S is discharged. When the rear edge of the sheet S is discharged onto the discharge tray 17 by passing through the nip between the discharge roller pair 60 and 62, because the lifting force of the sheet S is eliminated, the flap 50 is lowered to return to the position 50b at the same time the rear end of the sheet S is discharged. Therefore, because the photointerrupter 70 is switched from ON to OFF, the optical sensor detects that the sheet S is discharged.

When the sheets are stacked on the discharge tray up to the limit stacking height by repeating a sequence of operations, the flag 50 remains at the position 50c and the ON state is continued even after the sheet is completely discharged. Whether or not the sheets are stacked on the discharge tray up to the limit stacking height (a predetermined amount of the sheets) is detected by confirming whether the photointerrupter 70 is turned on or off after a predetermined time or the ON-state time according to a sheet length. That is, the leading edge of the sheet S lifts the flag 50 to interrupt the light source of the photointerrupter 70, and the optical sensor detects again whether or not the light source of the photointerrupter 70 is interrupted after the conveyance time of the sheet length which is of the time necessary to completely discharge the sheet S. Therefore, it can be determined whether or not the sheets are stacked on the discharge tray up to the limit stacking height.

However, when the sheet S is not normally discharged because the sheet S remains in the discharge roller 60, the sheet S keeps the flag 50 lifted, and the ON state of the photointerrupter 70 is continued. In such cases, the discharge port is closed even if the sheet position is changed, and the sheet S is not normally discharged. Therefore, the detection process can be performed as discharge inability.

Another set of the photointerrupter 70 and the flag 50 with the shielding portion 71 may be arranged immediately before the discharge roller 60 on the upstream side. The construction can separately detect that the sheets are discharged on the discharge tray to the limit stacking height and that the sheet stagnates around the discharge portion.

In the second embodiment, the photointerrupter 70 is provided on the side of the frame 53, and the shielding portion 71 which interrupts the light source of the photointerrupter 70 is provided in the end portion of the flag 50 including the charge removing member. Therefore, not only the charges in the sheet are removed, but also the optical sensor can detect that the sheet reaches the discharge portion at normal timing and whether or not the sheets are stacked on the discharge tray to the limit stacking height.

### Other Embodiments

In the second embodiment, the charge removing member is provided on the contact portion side at one end of the lever member in relation to the pivot, and the shielding portion which turns on and off the sensor is provided at the other end. However, the invention is not limited to the second embodiment. The shielding portion is not limited to the other end in relation to the pivot. Alternatively, the shielding portion may be provided at any position where the contact between the sheet and the contact portion is not blocked as long as the shielding portion turns along with the lever member.

Although the printer is described as an example of the image forming apparatus in the above embodiments, the invention is not limited to the printer. For example, the invention can be applied to image forming apparatus such as a scanner, a copying machine, and a facsimile. The invention also applied to another type of image forming apparatus such as a multifunction machine in which the functions of the printer, the scanner, the copying machine, the facsimile, and the like are combined. The same effects can be obtained by applying the invention to the sheet conveyance apparatus used in image forming apparatus.

Although the sheet conveyance apparatus integrally formed in the image forming apparatus is described in the above embodiments, the invention is not limited to the above embodiments. For example, the invention can be applied to the sheet conveyance apparatus detachably attached to the image forming apparatus. The invention also applied to the sheet conveyance apparatus in a sheet processing apparatus which is detachably attached to or integrally provided in the image forming apparatus. The same effects can be obtained by applying the invention to these sheet conveyance apparatuses. In the above embodiments, the sheet conveyance apparatus is provided in the sheet discharge portion, and the charges in the sheet discharged and stacked on the discharge tray 17 are removed. Alternatively, the charges in the sheet may be removed before the image is formed in the sheet conveyed toward the image forming portion. In the electrophotographic type image forming apparatus, the charges in the sheet are particularly effectively removed before the image is formed.

Although the sheet conveyance apparatus for conveying the sheet such as recording paper which is of the recording target is described in the above embodiments, the invention is not limited to the above embodiments. For example, the same effects can be obtained even if the invention applied to the sheet conveyance apparatus for conveying the sheet such as an original which is of a reading target.

Although the electrophotographic type is described as the recording type in the above embodiments, the invention is not limited to the above embodiments. For example, the invention may be applied to other recording types such as an inkjet type.

This application claims the benefit of priority from the prior Japanese Patent Application No. 2006-021683 filed on Jan. 31, 2006 the entire contents of which are incorporated by reference herein.

What is claimed is:

1. A sheet conveyance apparatus comprising:
a conveyance portion which conveys a sheet;
a charge removing member which removes charge in the sheet; and
a moving member which is formed by an electro conductive member, and which is able to move by contact with the sheet conveyed by the conveyance portion;
wherein the charge removing member is moved with the moving member, the charge removing member being not in contact with the conveyed sheet, and being within a range where the charge in the sheet can be discharged into the charge removing member.

2. A sheet conveyance apparatus according to claim 1,
wherein the moving member has a flat and smooth surface for contact with the sheet.

3. A sheet conveyance apparatus according to claim 1,
wherein the charge removing member is provided at a position on a leading-end side of the moving member, which is brought closest to the conveyed sheet, the charge removing member keeping a constant distance from the conveyed sheet in a contactless manner at the position.

4. A sheet conveyance apparatus according to claim 1,
wherein the charge removing member is a nonwoven fabric made of electro conductive fiber.

5. A sheet conveyance apparatus according to claim 1,
wherein the conveyance portion has a conveyance roller which discharges the sheet toward a stacking portion, and the moving member contacts the conveyed sheet at a downstream side of the conveyance roller in a sheet discharge direction.

6. A sheet conveyance apparatus according to claim 5,
wherein the moving member is a detection member which abuts on the sheet stacked on the stacking portion to detect a predetermined stack amount of the sheets.

7. A sheet conveyance apparatus according to claim 1,
wherein the conveyance portion has a conveyance roller which can be rotated normally and reversely.

8. A sheet conveyance apparatus according to claim 1,
wherein the moving member constitutes a part of a ground path of the charge removing member.

9. A sheet conveyance apparatus according to claim 1,
wherein the moving member is formed by an electro conductive plastic member in which an electro conductive material is added to a plastic member, and the moving member constitutes a part of a ground path of the charge removing member.

10. A sheet conveyance apparatus according to claim 1,
wherein the moving member includes a shielding portion which turns on and off an optical sensor.

11. An image forming apparatus comprising:
an image forming portion which forms an image on a sheet; and
a sheet conveyance apparatus conveys the sheet on which the image is formed by the image forming portion, including:
a conveyance portion which conveys a sheet;
a charge removing member which removes charge in the sheet; and
a moving member which is formed by an electro conductive member, and which is able to move by contact with the sheet conveyed by the conveyance portion;
wherein the charge removing member is moved with the moving member, the charge removing member being not in contact with the conveyed sheet, and being within a range where the charge in the sheet can be discharged into the charge removing member.

12. An image forming apparatus according to claim 11,
wherein the charge removing member is provided at a position on a leading-end side of the moving member, which is brought closest to the conveyed sheet, the charge removing member keeping a constant distance from the conveyed sheet in a contactless manner at the position.

13. An image forming apparatus according to claim 11,
wherein the charge removing member is a nonwoven fabric made of electro conductive fiber.

14. An image forming apparatus according to claim 11,
wherein the moving member is a detection member which abuts on the sheet stacked on the stacking portion to detect a predetermined stack amount of the sheets.

15. An image forming apparatus according to claim 11,
wherein the moving member constitutes a part of a ground path of the charge removing member.
